(19) United States
(12) Patent Application Publication
(10) Pub. No.: US 2002/0017239 A1
(43) Pub. Date: Feb. 14, 2002

(54) Device for spraying coating material comprising a nozzle

(75) Inventors: Michel Di Gioia, Pariset (FR); Francois Vasseur, Grenoble (FR)

Correspondence Address: BROWDY AND NEIMARK, P.L.L.C., 624 NINTH STREET, NW, SUITE 300, WASHINGTON, DC, 20001-5303, US

(73) Assignee: Sames Technologies, Meylan (FR)

(21) Appl. No.: 09/920,721

(22) Filed: Aug. 3, 2001

(30) Foreign Application Priority Data
Aug. 7, 2000 (FR) 00 10404

(51) Int. Cl. B05C 5/00

(52) U.S. Cl. 118/704

(57) ABSTRACT

This invention relates to a device for spraying coating material, which comprises a barrel inside which is defined a conduit for circulation of coating material, and a nozzle for shaping the jet of material intended to be mounted on this barrel. Magnetic coupling means are provided between the nozzle and the barrel. These means which are insulated from the conduit, may be formed by one or more magnets associated with a metallic ring. This allows easy and rapid assembly and dismantling of the nozzle on the end of the barrel.

### FIELD OF THE INVENTION

The present invention relates to a device for spraying coating material, equipped with a nozzle.

### BACKGROUND OF THE INVENTION

In an installation for spraying liquid or particulate coating material, it is known to spray the material by discharging it from the downstream end of a conduit provided in the barrel of a manual or automatic spray gun. A nozzle is generally used to shape the jet of sprayed coating material as a function of the type of application.

It is known to screw a nozzle on the downstream end of a barrel. Such a screwing operation is relatively long and requires particular care for a thread and a tapping provided respectively on the barrel and the nozzle to cooperate correctly. Such thread and tapping are most often made of the plastic material constituting the barrel and the nozzle, particularly for electrostatic spray guns. Consequently, they may be distorted in the case of poor manipulation. In addition, it may be that coating material accumulates on the thread and tapping, whether it be question of droplets of liquid coating material or of particles of powder. Now, it is often necessary to dismantle and clean a shaping nozzle after several hours of use in order to evacuate agglomerates which may be formed inside and/or outside the nozzle. This involves repeated manipulations of unscrewing and screwing of a nozzle on the barrel, with the drawbacks set forth hereinabove.

It is a more particular object of the present invention to overcome these drawbacks by proposing an improved solution for a rapid assembly and dismantling of a shaping nozzle at the end of the barrel of a spray gun.

### SUMMARY OF THE INVENTION

To that end, the invention relates to a device for spraying coating material, comprising a barrel, inside which is defined a conduit for circulation of coating material, and a nozzle for shaping the jet of material, said nozzle being intended to be mounted on said barrel, characterized in that it comprises means for magnetic coupling between said nozzle and said barrel, such means being insulated from the afore-mentioned conduit.

Thanks to the use of magnetic coupling means, the assembly and dismantling of the nozzle on and from the barrel are particularly rapid operations, since it suffices to bring the nozzle sufficiently close to the barrel for the magnetic coupling to produce an effective connection. Inversely, dismantling takes place simply by moving the magnetic coupling means apart from one another. These magnetic coupling means also allow a magnetic self-centering of the nozzle with respect to the barrel. In addition, as the coupling means are insulated from the conduit for circulation of material when the nozzle is in configuration mounted on the barrel, they do not risk being soiled or clogged by a deposit of material. This contributes to the durability of the coupling obtained.

According to an advantageous aspect of the invention, the nozzle is provided with a ring forming a peripheral partition of a terminal part of the conduit, this ring being disposed between this conduit and the magnetic coupling means. This ring efficiently insulates the coupling means from the flow of coating material.

According to a first embodiment of the invention, the barrel is equipped with at least one magnet adapted to cooperate with a magnetic looping element borne by the nozzle.

According to another advantageous embodiment of the invention, the nozzle is equipped with at least one magnet adapted to cooperate with a magnetic looping element borne by the barrel.

Whatever the embodiment in question, the coupling means may be provided to be located around the barrel. In that case, these means are disposed at a distance from the head of the spray gun in which an electrostatic charge, in the case of an electrostatic spray gun, might be likely to accumulate. In other words, the fact of disposing the magnetic coupling elements at a distance from the zones likely to be at a high voltage potential, limits the risks due to the electrical capacitance of the metallic masses constituting these coupling means and, in particular, the magnets and/or metallic rings used.

According to another advantageous aspect of the invention, the looping means is formed by a metallic ring centred on a longitudinal axis of the conduit and of the nozzle.

According to another advantageous aspect of the invention, the device comprises means for mechanically centering the nozzle on the barrel, these centering means being adapted to allow a relative pre-positioning of the magnetic looping means when mounting the nozzle on the barrel.

According to another advantageous aspect of the invention, the magnetic looping means, provided in the nozzle, form contacts of a circuit supplying voltage to means for electrostatically charging the material. In that case, these contacts are advantageously formed by an end of a magnet and by a magnetic looping element in the form of a metallic ring.

In addition, the device may be provided to comprise controlled means for injection of a separation fluid between the barrel and the nozzle, with a sufficient pressure to overcome the effort of coupling of the coupling means. This makes it possible to create a system for pneumatic dismantling of the nozzle. In that case, the afore-mentioned control means may be mounted in or on the device, preferably in or on the barrel. These means may be controlled manually or automatically.

According to another advantageous aspect of the invention, the coupling means used, and in particular the magnets and rings, are dismountably installed on the barrel and/or on the nozzle. This facilitates maintenance of the device.

### BRIEF DESCRIPTION OF THE DRAWINGS

The invention will be more readily understood on reading the following description of three embodiments of a coating material spray device in accordance with its principle, given solely by way of example with reference to the accompanying drawings, in which:

FIG. 1 is an exploded axial section of the downstream end of a spray device in accordance with a first embodiment of the invention.

FIG. 2 is a section along line II-II in FIG. 1.

FIG. 3 is an axial section on a larger scale of the device of FIG. 1 in mounted configuration.

FIG. 4 is a view similar to FIG. 3 for a device in accordance with a second embodiment of the invention, and

FIG. 5 is a side view, with partial longitudinal section, of a device in accordance with a third embodiment of the invention.

### DESCRIPTION OF PREFERRED EMBODIMENTS

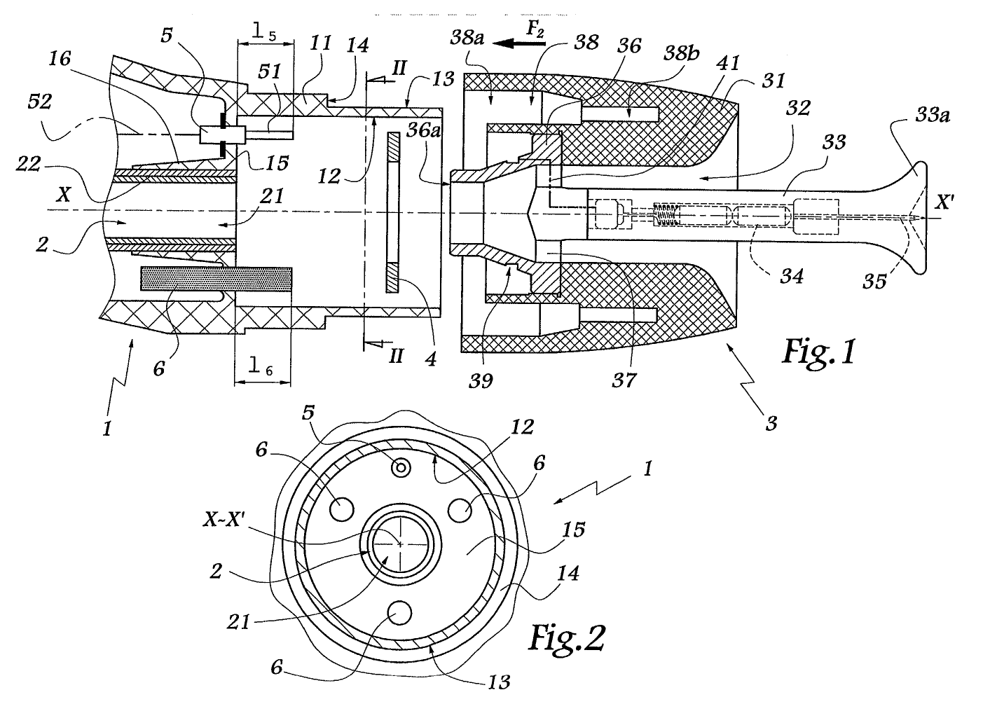

Referring now to the drawings, the device shown partially in FIGS. 1 to 3 comprises a barrel 1 of which only the downstream end has been shown. This barrel is centered on an axis X-X′ which also constitutes the axis of symmetry of a conduit 2 through which the coating material flows. In the example shown, the spray gun is used with a pulverulent coating material, with the result that a mixture of air and powder transits through the conduit.

The barrel 1 terminates in a sleeve 11 which extends the barrel 1 beyond the opening 21 of the conduit 2. The sleeve 11 is defined by a cylindrical internal surface 12 with straight generatrix, and by a likewise cylindrical external surface 13 forming an outer shoulder 14.

A web 15 extending along a plane substantially perpendicular to axis X-X′ connects the sleeve 11 and the outer surface of the barrel 1 to a sleeve 16 forming housing for receiving the downstream end 22 of the conduit 2. In the example shown, the conduit 2 is formed by two concentric tubes in its downstream part 22, but this is not compulsory.

A nozzle 3 is provided to be mounted on the barrel 1 and comprises a principal body 31 defining a central conduit 32 for circulation of the mixture of air and powder. A rod 33 is disposed in the channel 32 and contains electronic components 34 for supplying high voltage to an electrode 35 provided in the downstream end 33a of the rod 33 which forms a deflector for the jet of air/powder mixture. The rod 33 is fast with a ring 36 by means of tabs 37, the ring 36 being immobilized in the body 31 for example by screwing.

The body 31 forms an annular housing 38 intended to cover the sleeve 11, this housing comprising a first section 38a of width greater than a second section 38b forming the bottom of the housing 38. The geometry of the housing 38 makes it possible to accommodate the sleeve 11, the width of the sections 38a and 38b being adapted to the two successive widths of the sleeve 11 on either side of the shoulder 14.

The nozzle 3 is equipped with a steel ring 4 dismountably installed in a housing 39 provided around the ring 36. The ring 4 may be clipped in the housing 39 or fixed by any other means. However, a dismountable mode of fixation is preferred in order to facilitate maintenance of the nozzle 3.

A conductor 41 is provided in the ring 36 and on one of the tabs 37 in order to connect the ring 4 to one of the components 34 when the ring 4 is in position in the housing 39.

A contactor 5 is mounted in the barrel 1, through the web 15, and comprises a rod 51 projecting beyond the web 15 towards the front of the barrel 1.

When the device is in mounted configuration, the axis X-X′ is a longitudinal axis of the conduit 2 and of the nozzle 3.

When the device is in mounted configuration, the rod 51 is in electrical contact with the ring 4, which makes it possible to apply to the components 34 a voltage supplied by the contactor 5 itself supplied via an electric cable 52 from a high voltage generating unit (not shown). In the event of a high-voltage cascade being integrated in the barrel 1, the contactor 5 is supplied directly therefrom. In any case, it is possible to supply the electrode 35 with high voltage, through the components 34, in order to create an electrostatic charge at the level of the deflector 33a.

Three magnets 6 are removably mounted in the web 15 and extend from the latter over a length 1₆ substantially equal to the length 1₅ of the contactor beyond the web 15.

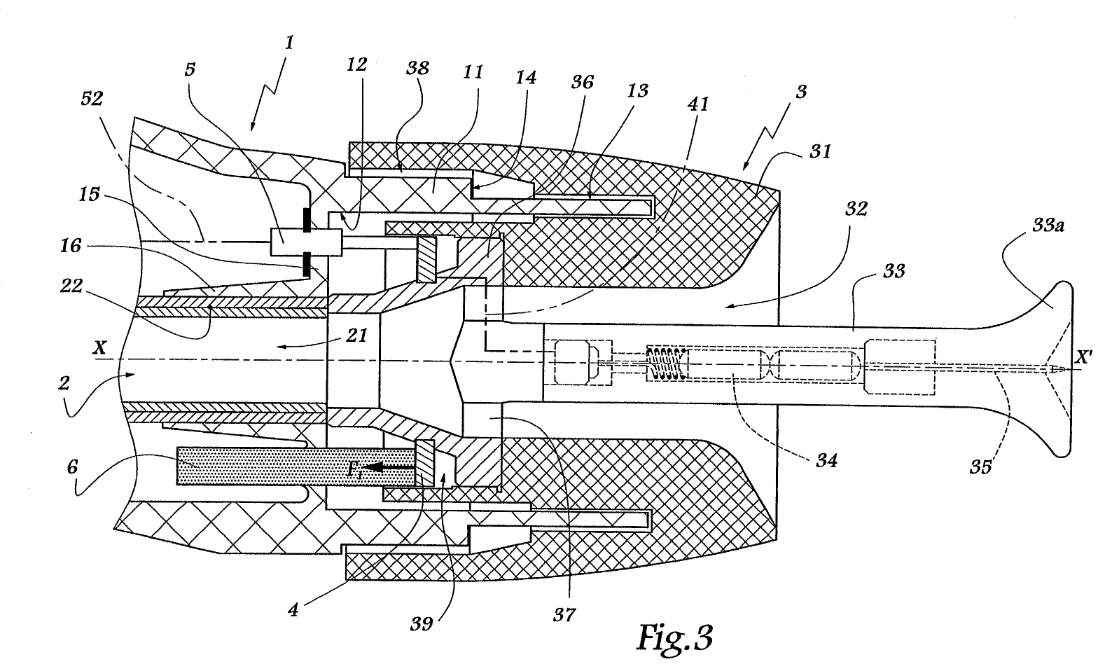

When the device is in mounted configuration shown in FIG. 3, the magnets 6 are therefore in contact with the ring 4 on which they exert an effort of traction F₁ which applies the nozzle 3 firmly on the body 1.

In this way, elements 4 and 6 constitute means for magnetic coupling between the barrel 1 and the nozzle 3.

It will be noted that, in the configuration of FIG. 3, the ring 36, which extends the conduit 2, insulates the volume of circulation of the coating material in the conduit 2 and the conduit 32 with respect to the ring 4 and to the magnets 6, with the result that the risks of deposit of material on the elements 4 and 6 are minimized. In particular, the front end surface 36a of the ring 36 is in firm abutment, under the effect of the effort F₁, against the downstream end of the conduit 2. The risks of leakage towards the outside of the ring 36 are thus reduced.

As is more particularly visible in FIG. 2, the device comprises three magnets 6 regularly distributed around axis X-X′. The number of magnets and their distribution depend on the intensity of the desired effort F₁.

It may be envisaged to use an annular magnet centred on axis X-X′. However, this solution presents the drawback of creating a relatively high metallic capacitance near the discharge orifice of the spray gun, which proves detrimental in terms of electrical energy stored in this part of the device.

The sleeve 11 and the housing 38 allow a relative pre-positioning of the nozzle 3 and of the barrel 1, and in particular, of the magnetic coupling elements 4 and 6 with respect to one another, during the movement of approach of the nozzle 3 with respect to the barrel 1, this movement being represented by arrow F₂ in FIG. 1.

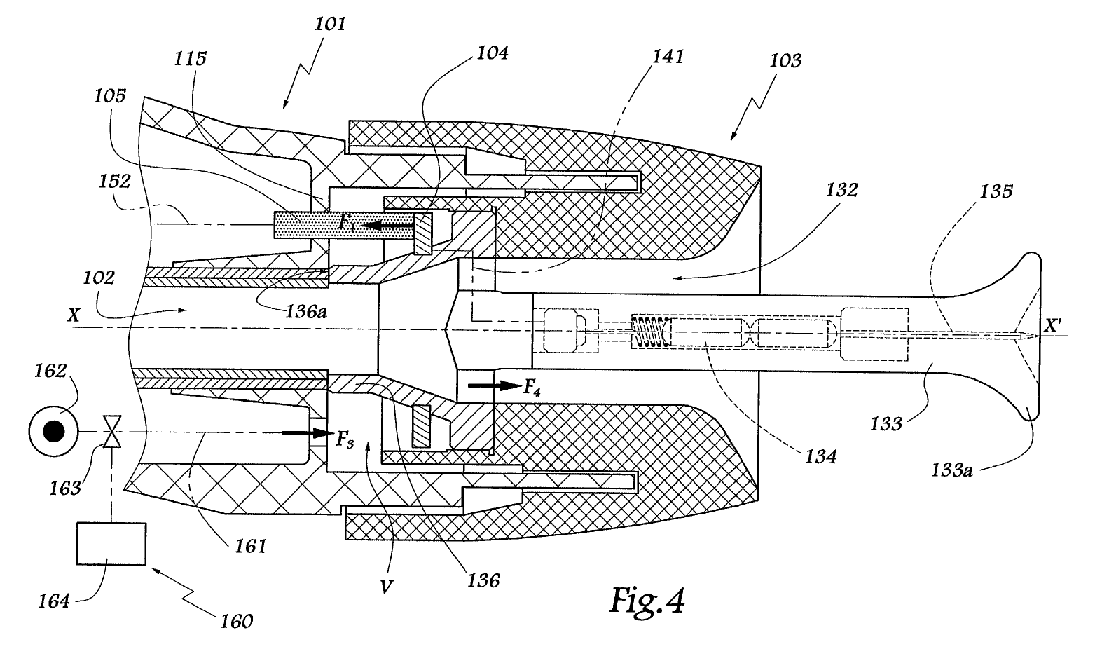

In the second embodiment of the invention, shown in FIG. 4, elements similar to those of the first embodiment bear identical references increased by 100. In this embodiment, the barrel 101 of a spray is equipped with a nozzle 103 and comprises a conduit 102 opening out opposite a central conduit 132 formed by the nozzle 103 around a rod 133 terminating in a deflector 133a equipped with a charging electrode 135 supplied by electronic components 134 arranged in the rod 133.

A ring 136 belonging to the nozzle 103 abuts, by its end surface 136a, against the downstream end of the conduit 102 and surrounds conduit 132, thus guaranteeing that the material remains in the conduits 2 and 102 that it insulates from the outside.

As hereinbefore, the nozzle 103 is provided with a metallic ring 104 electrically connected to the components 134 by a cable 141. The ring 104 is supplied with current via a contactor 105 made in the form of a magnet and itself supplied by conducting cables 152. In this way, the contactor 105 of this embodiment simultaneously performs the role of the elements 5 and 6 of the first embodiment.

One sole magnet-contactor 105 may be used, as long as the effort of attraction F₁ exerted is sufficient.

A pneumatic dismantling system 160 is provided, which comprises a pipe 161 traversing the end web 115 of the barrel 101 and connected to a source 162 of pressurized air through an electro-valve 163 controlled by a logic unit 164. When the nozzle 103 is to be disconnected from the barrel 101, the electro-valve 163 is opened, so that a flow of air, represented by arrow F₃, is injected in the volume V defined between the barrel 101 and the nozzle 103, which has the effect of exerting on the nozzle 103 an effort F₄ which is sufficient to overcome the effort F₁ of magnetic coupling.

An optional pneumatic dismantling system may, of course, also be used with the device of the first embodiment.

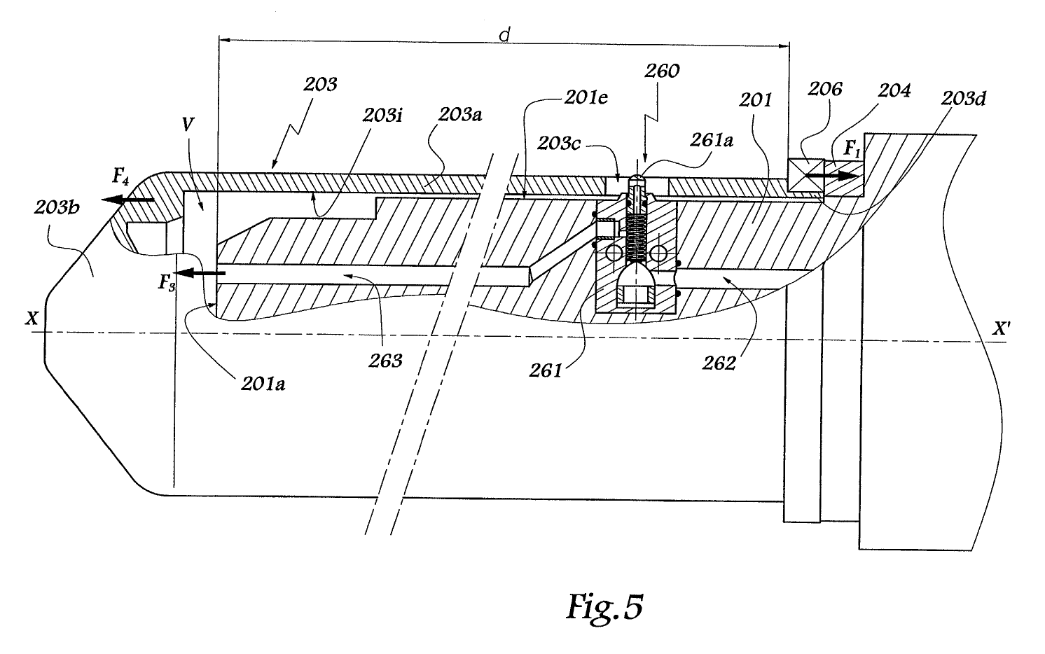

In the third embodiment of the invention shown in FIG. 5, elements similar to those of the first embodiment bear identical references increased by 200. In this embodiment, the barrel 201 of an automatic liquid paint spray gun is covered by a nozzle 203 which comprises a skirt 203a surrounding the barrel 201 over the major part of its length, this skirt being in one piece with the head 203b of the nozzle 203. However, the nozzle 203 might be constituted by two assembled elements.

The skirt 203 bears, at the level of its edge opposite the head 203b, a magnet 206 of annular shape and centred on the longitudinal axis X-X′ of the nozzle 203 and of the barrel 201 when the spray gun is in mounted configuration. A metallic ring 204 is permanently mounted around the barrel 201 in a position such that the magnet 206 comes into abutment against the ring 204 when the nozzle 203 is in place on the barrel 201. An intense magnetic effort F₁ is thus created between the magnet 206 and the ring 204, this effort guaranteeing an adequate and long-lasting positioning of the nozzle 203 with respect to the barrel 201.

The distance d between the magnet 206 and the front face 201a of the barrel 201, taken when the device is in mounted configuration, is such that an electrical insulation is made and that the metallic pieces 204 and 206 do not risk being charged with high voltage, including when the sprayed liquid coating material is charged with high voltage due to an inner charging system or when the head 203b is equipped with electrodes for external charging of the liquid material.

The inner radial surface 203i of the skirt 203a and the outer radial surface 201e of the barrel 201 present corresponding geometries making it possible to guide and to centre the nozzle 203 when it is mounted on the barrel and, consequently, to position the magnet 206 correctly with respect to the ring 204.

A pneumatic dismantling system 260 is provided, which comprises a self-closing push button 261 installed in the barrel 201 and connected by a pipe 262 to a source of pressurized air (not shown). The downstream part of the push button 261 is connected by a pipe 263 to the volume V defined between the barrel 201 and the head 203b. As before, this system makes it possible to inject into the volume V a flow of air, represented by arrow F₃, to exert an effort F₄ sufficient to overcome the effort F₁ of magnetic coupling. The push button 261 is actuated thanks to a head 261 a easily accessible through an opening 203c provided in the skirt 203a.

Other variants may, of course, be envisaged and an automatic control system may be used in place of the manual push button 261.

The skirt 203a may also be shorter than in the example shown in FIG. 5, in which case the distance d is shorter. Nonetheless, this makes it possible to obtain a good insulation of the metallic elements with respect to the high voltage essentially present in or in the immediate proximity of the volume V. In that case, the push button 261 may be located towards the rear of the spray gun with respect to the magnetic coupling elements. It is thus accessible without the need to create an opening in the skirt.

The skirt 203d of the terminal part of the nozzle 203 which bears the magnet 206 abuts against the barrel 201 and the ring 204, with the result that it insulates the elements 204 and 206 from the volume V which is itself advantageously insulated from the conduit for circulation of the coating material.

The invention may be used with a spray of manual or automatic type and may be employed for spraying liquid or pulverulent coating material. In particular, the technical characteristics of the different embodiments shown may be combined together.

According to a variant of the invention (not shown), the rings 4, 104 and 204 may be replaced by one or more metal studs capable of cooperating with magnets in order to create a magnetic looping by reducing the electrical capacitance of the nozzle.

A mixed variant, with magnets and coupling studs provided both on the barrel and the nozzle, may likewise be envisaged.

What is claimed is:

1. Device for spraying liquid or pulverulent coating material, said device comprising a barrel, inside which is defined a conduit for circulation of a coating material, and a nozzle for shaping the jet of material intended to be mounted on said barrel, wherein it comprises means for magnetic coupling between said nozzle and said barrel, and said magnetic coupling means are insulated from said conduit.

2. The device of claim 1, wherein said nozzle is provided with a ring forming a peripheral partition of a part of said conduit, said ring being disposed between said conduit and said magnetic coupling means.

3. The device of claim 1, wherein said barrel is equipped with at least one magnet adapted to cooperate with a magnetic looping element borne by said nozzle.

4. The device of claim 1, wherein said nozzle is equipped with at least one magnet adapted to cooperate with a magnetic looping element borne by said barrel.

5. The device of claim 1, wherein said coupling means are located around said barrel.

6. The device of claim 3, wherein said looping means is a metallic ring centred on a longitudinal axis of said conduit and of said nozzle.

7. The device of claim 1, wherein it comprises means for mechanically centering said nozzle on said barrel, said centering means being adapted to allow a relative pre-positioning of said magnetic coupling means when said nozzle is mounted on said barrel.

8. The device of claim 1, wherein said magnetic coupling means, provided in said nozzle, form contacts of a circuit supplying voltage to means for electrostatically charging said material.

9. The device of claim 8, wherein said contacts are formed by one end of a magnet and by a magnetic looping element in the form of a metallic ring.

10. The device of claim 1, wherein it comprises controlled means for injecting a separation fluid between said barrel and said nozzle, with a sufficient pressure to overcome the effort of coupling of said coupling means.

11. The device of claim 10, wherein said controlled means for injection of a separation fluid are mounted in or on said device, preferably in or on said barrel.

12. The device of claim 1, wherein said coupling means are dismountably installed on said barrel and/or on said nozzle.
